(19) United States
(12) Patent Application Publication
(10) Pub. No.: US 2004/0246511 A1
(43) Pub. Date: Dec. 9, 2004

(54) Method and system for graphically communicating print mode quality speed

(76) Inventors: Howard G. Wong, Portland, OR (US); Elizabeth Atwater, Vancouver, WA (US); Joyce Chua, Vancouver, WA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/456,234

(22) Filed: Jun. 6, 2003

(51) Int. Cl. G06F 15/00; G09G 5/00; G06F 3/12

(52) U.S. Cl. 358/1.13; 715/700; 345/173

(57) ABSTRACT

An electronic portion of a user interface for a printer includes a plurality of icons for display on a display device of the printer. Each icon graphically represents a particular print quality setting and an associated print speed.

### BACKGROUND

With a personal computer and an appropriate software package, a user can produce virtually any type of document that may be desired. For example, word processing software is used to produce text documents. Graphic design or computer-aided design software can be used to produce diagrams, charts, graphs, designs, etc. Spreadsheet software allows a user to manage large amounts of financial and other types of information. Database software similarly allows a user to manage various databases of information such as, client contact information, address and phone number information or “to do” items.

Frequently, it is desirable to generate a hardcopy of a document or data set that is produced or stored on a personal computer. A hardcopy may be desired, for example, for record keeping purposes or to share with another party. Consequently, a wide variety of printers and printing devices have been developed that can receive a print job from a host computer and produce a hardcopy of the document or data represented by that print job. In order to save space, particularly in home offices, many users employ a multi-function peripheral (MFP) with a host computer. A multi-function peripheral is a device that combines some form of printer with one or more of the following: a scanner, a copier, or a facsimile machine.

As used herein and in the appended claims, the terms “printer” and “printing device” are defined to mean any device that produces a hardcopy from electronic data, including, but not limited to, laser printers, inkjet printers, dot matrix printers, plotters, facsimile machines, digital copiers, photocopiers, multi-function peripherals, and the like. A printer or printing device may produce images on a variety of print media that are in color or are monochromatic.

The term “print job” is defined as data that has been specifically formatted for submission to a particular printer from which the printer can generate a hardcopy representing an underlying data set from which the print job was created.

Most personal computers include programming that will be referred to generally as a “printer driver.” A printer driver is a piece of software or firmware that receives data or a document to be printed from an application running on the computer. The printer driver formats the data for use by a corresponding printer, i.e., creates a print job, and then transmits the print job to the printer. Using the print job, the printer can produce a hardcopy of the underlying data or document.

A common characteristic of printers is that the quality of the print job produced is directly proportional to the time required to print the job. When a high quality print is desires, such as for a photograph, the printer will require more time to print the hardcopy. If print quality is less important, such as for a rough draft of a text document, the printer can produce the lower-quality print job in less time.

### SUMMARY

An electronic portion of a user interface for a printer includes a plurality of icons for display on a display device of the printer. Each icon graphically represents a particular print quality setting and an associated print speed.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is an illustration of a host computer and a printer according to an embodiment of the present invention.

FIG. 2 is an illustration of a user interface panel from an exemplary prior art printer.

FIG. 3 is an illustration of a user interface panel for a printer according to one exemplary embodiment of the present invention.

FIG. 4 is a further illustration of the user interface panel for the printer of FIG. 3.

FIG. 5 is a further illustration of the user interface panel for the printer of FIG. 3.

FIG. 6 is a flowchart of an exemplary method of using the user interface panel of FIGS. 3-5.

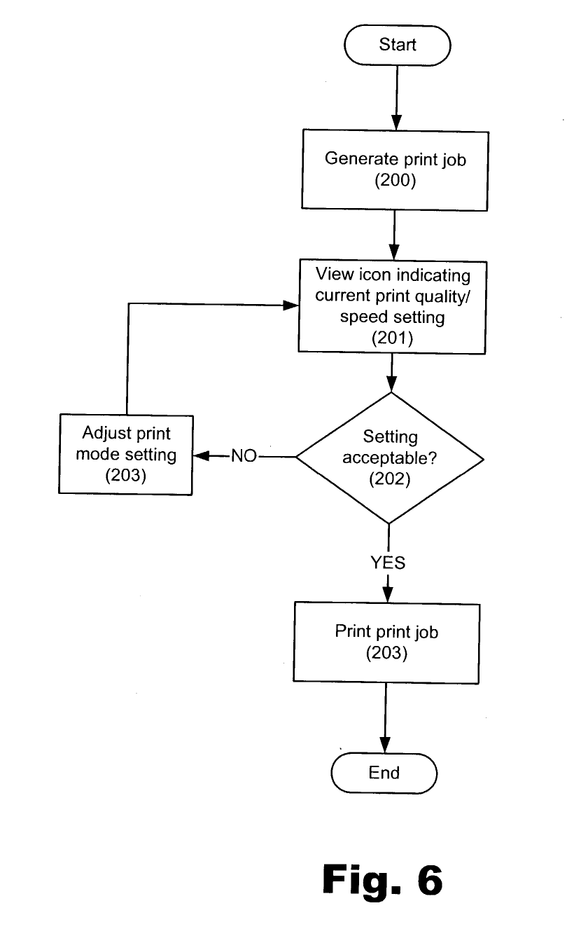

Throughout the drawings, identical reference numbers designate similar, but not necessarily identical, elements.

### DETAILED DESCRIPTION

As indicated above, a common characteristic of printers is that the quality of the print job produced is directly proportional to the time required to print the job. Producing a quality photograph, for example, takes a printer much longer than producing a draft of a text-only document. This trade off between print speed and print quality should be communicated to the printer user so that the user can select the desired print quality while appreciating the time required to print the job at that selected quality level. If print quality is important, the user may be willing to accept a longer print time to produce a document at a high print quality setting. If print quality is not as important, the user may prefer to have the document printed more quickly and at a lower quality setting. In any event, the trade off between print quality and print speed should be readily communicated to a user. Moreover, because a printer may be purchased and used anywhere in the world, it will be preferred in some embodiments that the means for communicating the tradeoff between print quality and print speed be intuitive and independent of a particular written language.

This specification describes a system and method for intuitively communicating to a printer user the current or previously selected print quality setting and the associated print speed that results at that print quality setting. In some embodiments, an icon including familiar symbols for both print quality and print speed is displayed on the printer and/or on a host computer to inform the user of the print mode that is selected. “Print mode” refers to a particular print quality and related or consequent print speed.

Communicating print mode and print speed settings using a graphic icon more readily informs a user of the selected or default print quality and associated print speed. Moreover, the use of symbols in a graphic icon eliminates the need for text labels in a particular language. This makes the printer more widely useable around the globe by people who speak a variety of languages.

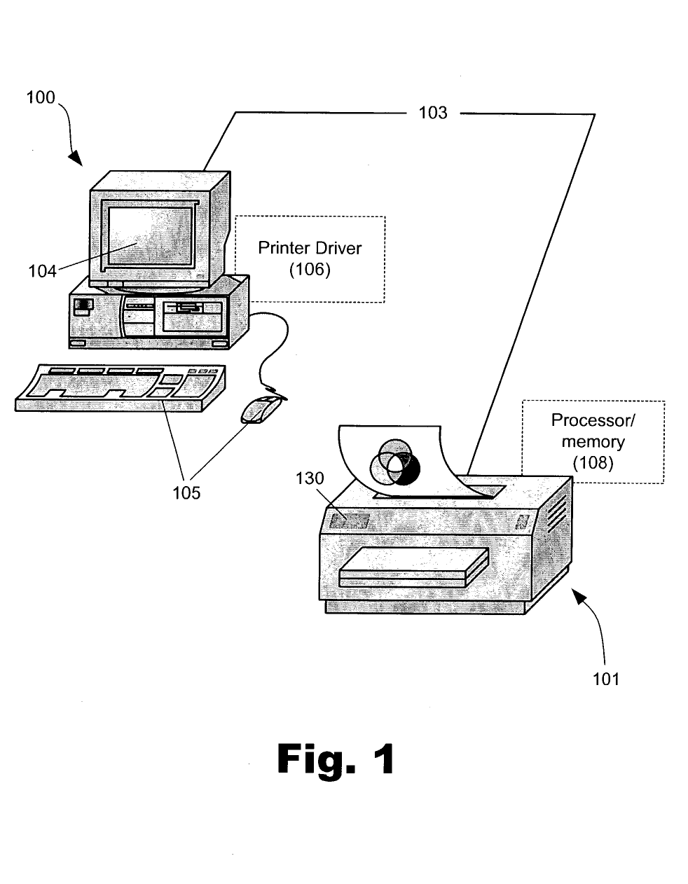

FIG. 1 illustrates a basic system in which a host computer (100) is connected to a printer (101). The host computer (100) typically includes a monitor (104). The monitor (104) is used to interface with the user by displaying, for example, the output of the application with which the user is working. User input devices (105), such as a keyboard and mouse allow the user to input or manipulated data being processed by the application running on the host computer (100). In this way, the user can create the desired result, be it a document, graphic, etc.

When the user has completed a work on the host computer (100) for which a hard copy rendering is desired, the user typically enters a print command to the application with which the work was generated. The application then calls another program on the host (100) known as a printer driver (106). The application passes the data of the work to be printed to the printer driver (106). As mentioned above, the printer driver (106) then converts this data into a print job.

In the configuration shown in FIG. 1, the printer driver (106) formats the data into a print job to be received by the printer (101) and rendered by a print engine of the printer (101) in hard copy form. The printer driver (106) then passes the formatted print job data over a connection (103) to the printer (101). The connection (103) may be a direct serial or parallel connection. Alternatively, the connection (103) may be a network, such as a Local Area Network (LAN) or the Internet, to which both the host computer (100) and the printer (101) are connected. Other types of connections such as a wireless link are also possible means for transferring the print job to the printing device.

In the case of an MFP, the print job may come from the printer driver (106) of a host computer (100) as described, or the print job may be generated within the MFP device itself for a hard copy rendering of such things as a photocopies, facsimiles, or scanned images. In the case of an MFP device that processes a hard copy rendering of data generated locally on the MFP device, a local printer driver on the MFP may prepare the print job as the data is received from one of the other components of the MFP device, such as a scanner, photocopier, or facsimile machine.

When the print job is received by the printer (101), it is submitted to a print engine within the printer (101). The print engine then renders the print job as a hard copy document on a print medium. The print medium may be, but is not limited to, paper, cardstock, envelopes, labels, etc.

The printer driver (106), in addition to formatting the print job for the printer (101), may also allow the user to control some characteristics of the print job. A user interface to the printer driver (106) maybe provided on the host computer (100) or on the printing device itself through which the user can specify, for example, the size of paper on which the print job is printed, whether the print job has a portrait or landscape orientation, whether the print job should be in color or gray scale, whether the print job will be enlarged or reduced in size, etc.

Through the printer driver (106), the user may also be able to specify the print mode, i.e., the print quality and speed, of the print job. For example, if it is important that the resulting hard copy look good, the user may specify a high print quality. This will typically require more toner or ink from the printer (101) and take longer to generate the printed document. However, if it is not important that the print job has a high print quality, the user can specify a lower print quality using the printer driver (106). In this way, toner will be conserved and the resulting document can typically be printed more quickly.

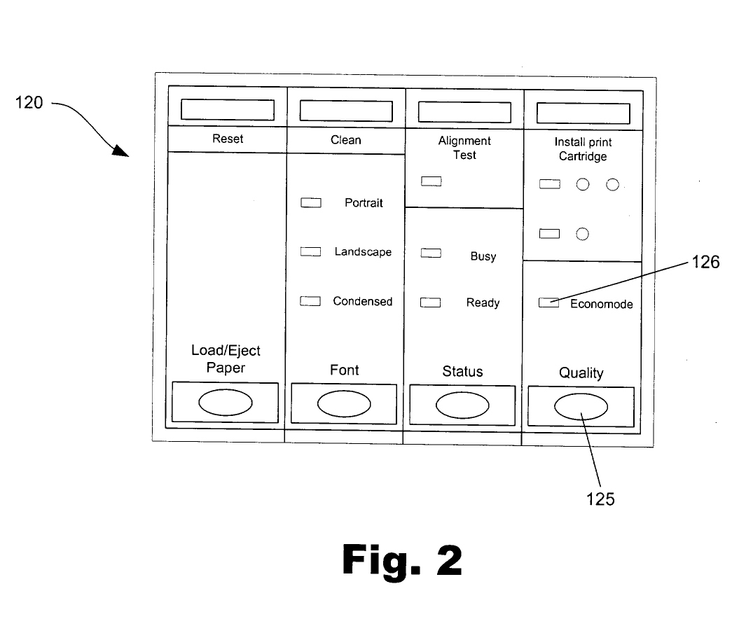

In addition to the possibility of selecting a desired print quality through the printer driver (106), the user may also be able to select a desired print quality through a user interface (120) located on the printer. An example of such a user interface is illustrated in FIG. 2. This user interface (120) includes, for example, a button (125) labeled “Quality” and an indicator lamp, such as a Light Emitting Diode (LED) (126), labeled with the text “Economode.”

Using this interface (120) to select a print mode is thus limited to selecting one of two print quality levels, a lower print quality (“Economode”) or a higher print quality. The selection is communicated to the user by the illumination of the LED (126). When the LED (126) is lit, the printer will print in “Economode,” i.e., faster print speed, lower print quality. If the LED (126) is not lit, the printer will print with a higher print quality and slower print speed. The user can operate the “Quality” button (125) to toggle between the two different print modes.

Similarly, in other printing devices, such as MFP devices which are being used to make photocopies or print an incoming facsimile, a selected print quality option may be communicated to the user through a series of indicator lamps and associated text labels that indicate the range of print mode options that can be selected, for example, “Best”, “Normal”, or “Fast”. The indicator lamps, again, may be LEDs. The LED next to the label for the currently selected print mode will be lit while the other indicators are not lit.

As noted above, printers are designed, manufactured and used throughout the world. In consideration of this global market for printers, making the print mode selection available on a printer as described above, i.e., using a text label and associated indicator, would require that a different set of text labels be placed on each individual printer corresponding to the specific language where that printer will be used. This can be difficult and costly for manufacturing purposes and burdensome to purchasers.

Thus, as mentioned above, it would be desirable for printers to more effectively communicate to users the print quality selected and associated print speed. For example, if a user requests that a print job be sent to a printer having selected the highest possible quality print mode through a printer driver on a host computer, there is no way for the user to know by inspecting the printer prior to, or during, the print process that high quality was selected and a longer print time should be expected. Likewise, if a lesser print quality had been selected through the printer driver on the host computer, the printer will not communicate to the user that a lesser print quality had been selected and a faster print time should be expected.

Additionally, a user may desire and select the print mode for fast print speed, but may not be aware that the selection will result in a lesser print quality. Similarly, a user may desire and select a print mode for high print quality without being aware that the higher print quality will significantly increase the required print time.

Consequently, this specification describes a system and method for intuitively communicating to a printer user the current or previously selected print quality setting and the associated print speed that results at that print quality setting. Referring again to FIG. 1, in some embodiments, an icon comprising familiar symbols for both print quality and print speed is displayed on a user interface (130) of the printer and/or on a host computer to inform the user of the print mode that is selected.

The printer (101) includes a processor and memory (108) for storing firmware that is an electronic portion of the user interface (130). This firmware includes the icons communicating the print quality and print speed settings. These icons and their use will be discussed in greater detail below.

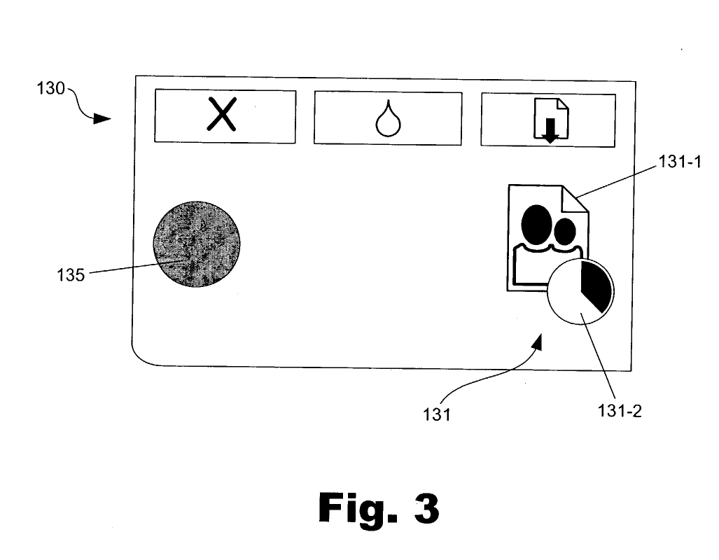

FIG. 3 illustrates a user interface that can be implemented as part of a printer driver (106) on a host computer or as part of a user interface that is provided on the printer itself. In the embodiment illustrated in FIG. 3, the illustrated user interface is part of a user interface panel (130) that is provided on a printer (101, FIG. 1).

As illustrated in FIG. 3, if the user chooses an option of high print quality for a given print job, the selection of such a print mode will result in the display of a high print quality icon (131) on the printer user interface panel (130) indicating the selection of high print quality and a related slower print speed. In the illustrated example, a photograph symbol (131-1) is shown as part of the icon (131) and represents a high print quality setting as graphics and photograph material are typically printed using the highest print quality option available. The photograph symbol (131-1) comprises, for example, an abstract page containing shapes, such as simplified human forms, that demonstrate to a user that the symbol (131-1) represents a photograph. In addition to the example illustrated, this symbol (131-1) can be made up of any type of graphic or other recognized representations that suggest to a user the selection of a high quality print mode.

In conjunction with the photograph symbol (131-1), a slow print speed abstract clock (131-2) is shown as part of the icon (131). The slow print speed abstract clock (131-2) comprises a circle representing a clock with a pie-slice or wedge shown inside the circle signifying a relative print time. The wedge is broader in the slow print speed abstract clock (131-2) than would be the case for other print modes since a high quality print mode setting requires more time to print a given print job than other possible settings. As alternatives to the clock symbol (131-2) illustrated, this symbol indicating print time can consist of various other types of symbols that suggest a relative amount of time to a user such as different types of clocks, an hour-glass, a bar graph, etc.

As indicated, the print speed abstract clock (131-2) contains a broad wedge to indicate the longer print time associated with high print quality. The print speed abstract clock (131-2) and photograph symbol (131-1) are displayed simultaneously to denote the association between high print quality and longer print time.

In FIGS. 3-5, the depictions of the printer user interface panel (130) may further include a user input means to select between different print mode settings. This input means is illustrated in FIGS. 3-5 as a button (135). Each depression of the button (135) changes the print mode or print quality setting of the printer (101). Thus, the user can selected a desired print mode setting by repeatedly pressing the button (135) until the desired print mode setting is indicated.

The user interface panel (130) may comprise a touch-screen and the elements illustrated in FIGS. 3-5 may be displayed on that touch-screen and selected, if appropriate, by pressure on the touch-screen over the displayed element, for example, button (135). Alternatively, the user interface panel (130) may include a combination of a display device and a physical user input device. The display device may be, for example, a liquid crystal display (LCD), for displaying such elements as the icon (131). The physical user input device may be, for example, a physical button having the same function as the virtual button (135).

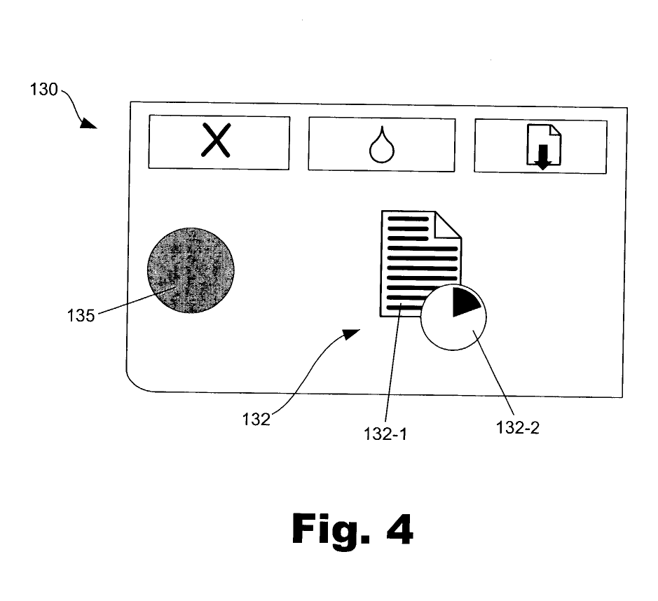

Continuing the example of FIG. 3, FIG. 4 shows a medium print quality icon (132) in the user interface panel (130) to represent a medium print quality selection and related print speed. This display may result from pressing the button (135) that selects between different available print mode settings.

In this case, a symbol (132-1) demonstrates to a user that a medium print quality setting was selected. In the illustrated embodiment, the medium print quality symbol (131-1) comprises an abstract page including thick or heavy lines representing high quality text. It will be understood that the illustrated icon (132) is merely exemplary. The icon (132) for indicating a medium print quality mode can include or consist of other types of graphics, print representations etc. that suggest to a user that a medium print quality setting has been selected.

Included in the medium print quality icon (132) is a medium print speed abstract clock (132-2). The medium print speed abstract clock (132-2) is similar to the slow print speed abstract clock (131-2) with the exception of the relative size of the wedge inside the circle. Because less print time is required for medium print quality as opposed to high print quality, a narrower wedge is displayed in the medium print speed abstract clock (132-2) than that associated with the slow print speed abstract clock (131-2) described above. Again, this clock symbol could alternatively consist of various other types of symbols that suggest an amount of time to a user such as different types of clocks, a half-spent hourglass, or a bar graph etc.

The display of the medium print quality icon (132) on the printer user interface panel (130) may signify to a user that medium print quality was selected. Consequently, for any upcoming print jobs, the print time will be less than that required for the higher print quality setting and more than would be required for a lower print quality setting.

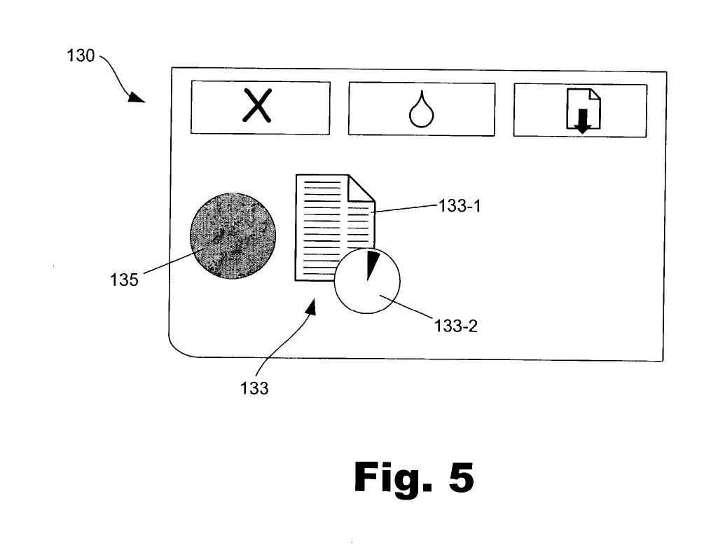

To complete the example, FIG. 5 illustrates an icon (133) that is displayed to indicate selection of a fast print speed, lower print quality setting. As with the foregoing print quality settings, the icon (133) reflects the selected print mode and related print speed. The fast print speed icon (133) includes a normal text symbol (133-1) and a fast print speed abstract clock (133-2). The normal text symbol (133-1) may be an abstract page containing thin lines. The thin lines denote to a user a fast print speed, lower print quality setting. This can also be symbolically represented by various other symbols such as printer representation, font representation etc. that suggest to a user the lower print quality setting.

The fast print speed abstract clock (133-2) differs from the abstract clocks mentioned above in the size of the wedge indicating the print time required. The fast print mode requires the least amount of print time for a given print job when compared to other print modes. Because of the lesser print time required, the wedge is narrower than the wedges of all other abstract clocks is displayed in abstract clock (133-2). As mentioned, this symbol can alternatively consist of various other types of symbols that suggest a lesser amount of time to a user such as different types of clocks, a nearly-spent hourglass, or a bar graph etc. If the fast print mode is selected, the fast print icon (133) reflects the selection and the associated lower print quality/faster print speed for any upcoming print jobs.

As mentioned above, the user interface panel (130) and the various icons described (131-133) can be provide directly on a printer (101, FIG. 1) for control of the print quality and print speed settings at the printer (101). However, referring again to FIG. 1, the user interface panel (130) and the icons (131-133) can also be incorporated into a printer driver (106) and displayed on a monitor (104) of a host computer (100).

Typically printers (101) and printer drivers (106) are configured to have and use a default print mode setting. Default print mode implies that initially a particular print mode is automatically selected by the printer (101) or printer driver (106) and remains in effect until another print mode option is selected by the user. The particular print mode of the default setting often can be manipulated as per user preference. In such cases, the appropriate print mode icon (131-133) is displayed on the printer (101) through panel (130) and/or on the host computer (100) through the printer driver (106). By inspection of the printer (101) or printer driver (106) running on the host computer (100) a user, thus, can easily determine the default print mode setting. By doing so, a user will know which print quality to expect for a given print job and the associated print time required according to default print mode settings or can select a setting different from the default setting.

A method for using the system described above is as follows. First, as a user desires to generate a hard copy rendering of any computerized data, the user will generate a print job of the data to be printed (step 200). This may be done with a printer driver (106, FIG. 1) on a host computer (100, FIG. 1) or may be done by scanning, copying or faxing a document to or with an MFP.

Originally, the printer or printer driver will expect to print the print job at the default print mode setting. An icon indicating the default print mode will then be displayed or indicated. As described above with regard to the icons (131-133), the icon displayed will give a graphic indication of both the print quality setting and the resulting print speed. The icon may be displayed in a printer driver (106, FIG. 1) or on a user interface panel (130, FIG. 1) on a printer (101, FIG. 1).

The user next views the icon (131-133) displayed to ascertain the print mode (print quality/speed) setting that will be used for the print job. (Step 201). The user then decides if that setting is acceptable given the necessary trade off between print quality and print speed. If the default setting is not acceptable (determination 202), the user can adjust the print mode setting, either in the printer driver (106) or through a user interface panel (130) on the printer (101). (Step 203). The user adjusts the setting, for example, by pressing the button (135, FIG. 3).

When the icon (131-133) that indicates the desired print mode setting, i.e., the desired print quality and associated print speed, is displayed (step 201), the user stops changing the setting (determination 202), and proceeds to print the print job (step 203). Consequently, the user is able to determine by inspecting the exhibited print mode icon (131-133) the print quality to expect for upcoming print jobs. At the same time the user will be able to ascertain from the print mode icon (131-133) the associated print time for upcoming print jobs. The user will be able to do so without the need to read and decipher text labels, which may be in a foreign language.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A user interface for a printer, said user interface comprising:
a plurality of icons, wherein each icon graphically represents a particular print quality setting and an associated print speed; and
a display device for displaying one or more of said icons and for indicating a selected print quality setting.

2. The user interface of claim 1, wherein each of said icons comprise:
a print quality symbol representing one of a plurality of available print quality settings; and
a print time symbol representing a print time associated with a particular print quality setting.

3. The user interface of claim 2, wherein said print quality symbol comprises a representation of a photograph or graphic indicating printing at a highest print quality setting.

4. The user interface of claim 2, wherein said print quality symbol comprises a representation of a text page indicating printing at a medium print quality setting.

5. The user interface of claim 2, wherein said print quality symbol comprises a representation of a draft text page indicating printing at a lowest print quality setting.

6. The user interface of claim 2, wherein said print time symbol comprises a circle representing a clock and a wedge of variable size in said circle, the size of said wedge representing a relative amount of print time required by an associated print quality setting.

7. The user interface of claim 1, wherein said display device is a touch-screen.

8. The user interface of claim 7, further comprising a displayed button on said touch-screen for selecting among said icons and print quality settings.

9. The user interface of claim 1, further comprising a user input device for selecting among said icons and print quality settings.

10. The user interface of claim 9, wherein said user input device comprises a physical button.

11. A printer for printing a hard copy from electronic data of a print job, said printer comprising:
a print engine for printing a hard copy document from electronic data; and
a user interface comprising
a plurality of icons, wherein each icon graphically represents a particular print quality setting and an associated print speed; and
a display device for displaying one or more of said icons and for indicating a selected print quality setting.

12. The printer of claim 11, wherein each of said icons comprise:
a print quality symbol representing one of a plurality of available print quality settings; and
a print time symbol representing a print time associated with a particular print quality setting.

13. The printer of claim 12, wherein said print quality symbol comprises a representation of a photograph or graphic indicating printing at a highest print quality setting.

14. The printer of claim 12, wherein said print quality symbol comprises a representation of a text page indicating printing at a medium print quality setting.

15. The printer of claim 12, wherein said print quality symbol comprises a representation of a draft text page indicating printing at a lowest print quality setting.

16. The printer of claim 12, wherein said print time symbol comprises a circle representing a clock and a wedge of variable size in said circle, the size of said wedge representing a relative amount of print time required by an associated print quality setting.

17. The printer of claim 12, wherein said display device is a touch-screen.

18. The printer of claim 17, further comprising a displayed button on said touch-screen for selecting among said icons and print quality settings.

19. The printer of claim 11, further comprising a user input device for selecting among said icons and print quality settings.

20. The printer of claim 19, wherein said user input device comprises a physical button.

21. Firmware for a printer stored on a medium for storing machine-readable instructions, said firmware comprising an electronic portion of a user interface comprising a plurality of icons for display on a display device of said printer, wherein each icon graphically represents a particular print quality setting and an associated print speed.

22. The firmware of claim 21, wherein each of said icons comprise:
a print quality symbol representing one of a plurality of available print quality settings; and
a print time symbol representing a print time associated with a particular print quality setting.

23. The firmware of claim 22, wherein said print quality symbol comprises a representation of a photograph or graphic indicating printing at a highest print quality setting.

24. The firmware of claim 22, wherein said print quality symbol comprises a representation of a text page indicating printing at a medium print quality setting.

25. The firmware of claim 22, wherein said print quality symbol comprises a representation of a draft text page indicating printing at a lowest print quality setting.

26. The firmware of claim 22, wherein said print time symbol comprises a circle representing a clock and a wedge of variable size in said circle, the size of said wedge representing a relative amount of print time required by an associated print quality setting.

27. The firmware of claim 22, wherein said display device is a touch-screen.

28. The firmware of claim 27, further comprising means for displaying a button on said touch-screen for selecting among said icons and print quality settings.

29. The firmware of claim 21, further comprising means for receiving input from a user input device for selecting among said icons and print quality settings.

30. A method of operating a printer, said method comprising:
displaying on or more of a plurality of icons, wherein each icon graphically represents a particular print quality setting and an associated print speed; and
indicating a selected print quality setting using one or more of said icons.

31. The method of claim 30, further comprising receiving user input for selecting among said icons to designate said selected print quality setting.

32. The method of claim 31, further comprising printing a print job at said selected print quality setting.

33. A printer comprising:
means for displaying on or more of a plurality of icons, wherein each icon graphically represents a particular print quality setting and an associated print speed; and
means for indicating a selected print quality setting using one or more of said icons.

34. The printer of claim 33, further comprising means for receiving user input for selecting among said icons to designate said selected print quality setting.

35. The printer of claim 34, further comprising means for printing a print job at said selected print quality setting.

36. A printer driver for a host computer, said printer driver being stored on a medium for storing machine-readable instructions, said printer driver comprising:
an electronic portion of a user interface for display on a monitor of said host computer, said electronic portion of a user interface comprising a plurality of icons for display on a display device of said printer, wherein each icon graphically represents a particular print quality setting and an associated print speed.

37. The printer driver of claim 36, wherein each of said icons comprise:
a print quality symbol representing one of a plurality of available print quality settings; and
a print time symbol representing a print time associated with a particular print quality setting.

38. The printer driver of claim 37, wherein said print quality symbol comprises a representation of a photograph or graphic indicating printing at a highest print quality setting.

39. The printer driver of claim 37, wherein said print quality symbol comprises a representation of a text page indicating printing at a medium print quality setting.

40. The printer driver of claim 37, wherein said print quality symbol comprises a representation of a draft text page indicating printing at a lowest print quality setting.

41. The printer driver of claim 37, wherein said print time symbol comprises a circle representing a clock and a wedge of variable size in said circle, the size of said wedge representing a relative amount of print time required by an associated print quality setting.
